(19) United States
(12) Patent Application Publication
(10) Pub. No.: US 2007/0050930 A1
(43) Pub. Date: Mar. 8, 2007

(54) Cleaning Shoe for CoatedPipe

(76) Inventor: Donald S. Holmes, Bessemer, AL (US)

Correspondence Address: Robert J. Veal, 8 Chaumont Sq., Atlanta, GA, 30327, US

(21) Appl. No.: 11/162,358

(22) Filed: Sep. 8, 2005

(51) Int. Cl. B08B 9/00

(52) U.S. Cl. 15/104.05

(57) ABSTRACT

A cleaning shoe designed to remove coating and irregularities from the interior of cast iron or pipe or the like utilized a generally rectilinear frame or core having at least one surface which is designed to remove such coating or irregularities from a rotating pipe when brought into contact with the interior surface of said pipe bearing such coating.

The present invention relates generally to the cleaning of cast iron, steel, or plastic tubing and pipe which has been lined. More particularly the present invention relates to the cleaning of the interior of such pipe to cement, glass, resin or other coatings and liners from the pipe or to remove burrs, blisters, and the like. In even greater particularity the present invention is a specially hardened shoe mounted for non-rotating axial reaming within a rotating tube.

The pipe industry produces thousands of linear feet of steel, cast iron, and plastic pipe each day. A substantial quantity of this pipe is coated internally as a part of the production process. For coated pipe imperfections in the coating process as well as imperfections in the underlying pipe can render the pipe section useless. A number of systems have been used to attempt to clean the interior of the pipe, most significantly my inventions as described in my prior U.S. Pat. Nos. 6,022,442 and 6,395,098 which are incorporated by reference. Typically, a lance will be mounted for axial movement into and out of the pipe and will carry grinding rocks or wire brushes or a combination of rocks and brushes. Normally, the grinding members, regardless of the type, are rotated on or with the lance such that they are urged against the interior of the pipe, which is also rotating to smooth or finish the inside of the pipe. Accordingly, motors and belts to drive the rotating grinders must be maintained and replaced to keep the equipment running. Special lances with special heads must be produced to support and rotate the reamer rocks or brushes, and special bearings for the lances must be provided. All of these components are somewhat sacrificial in that the rocks and brushes are soon worn away, and the motors, belts, lances, and bearings all must be maintained and replaced. The cost of cleaning pipe is explained in my previous patents. The present invention represents an improvement over the invention disclosed therein and provides a mechanism to clean small and large diameter pipe which has been coated with cement or glass or which has more severe imperfections than my earlier devices were designed to deal with.

It is an object of the present invention to provide a reamer mechanism that yields superior cleaning of the interior of a pipe or tube.

It is another object of the invention to provide a reamer mechanism that yields superior performance at a lower cost.

It is a further object of the invention to provide a mechanism for removing coatings from the interior of the pipe.

Still another object of the invention is to provide a reamer mechanism that reduces the time between maintenance events.

Yet another object of the invention is to provide a reamer mechanism which can clean the bell or spigot portion of a tube as well as the interior of the pipe.

These and other objects and advantages of my invention are accomplished by the novel and unique construction and utilization of my improved reamer head or shoe. My shoe is designed to be a passive grinder that is advanced within the bore of a pipe being rotated in a typical pipe cleaning operation. Specifically, my apparatus utilizes a lance for advancing the shoe within the pipe without rotation of the shoe. The shoe is affixed near the end of the lance in a selected attitude that determines the degree of grinding to be accomplished. The reaming shoe engages the pipe interior across a cord over the bottom of the rotating pipe. A hardening process enhances the cleaning characteristics and allows the shoe to remove cement or glass in a manner not contemplated in my prior patents.

Apparatus embodying features of my invention is depicted in the accompanying drawings which form a portion of this disclosure and wherein:

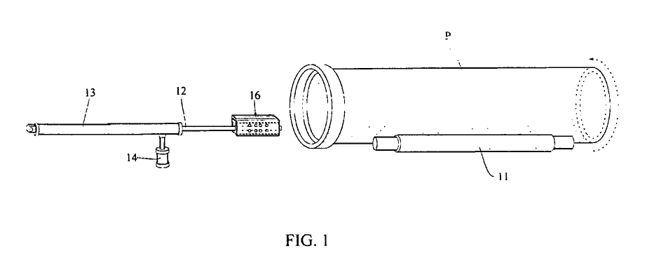

FIG. 1 is a pictorial representation of the equipment used to ream a pipe,

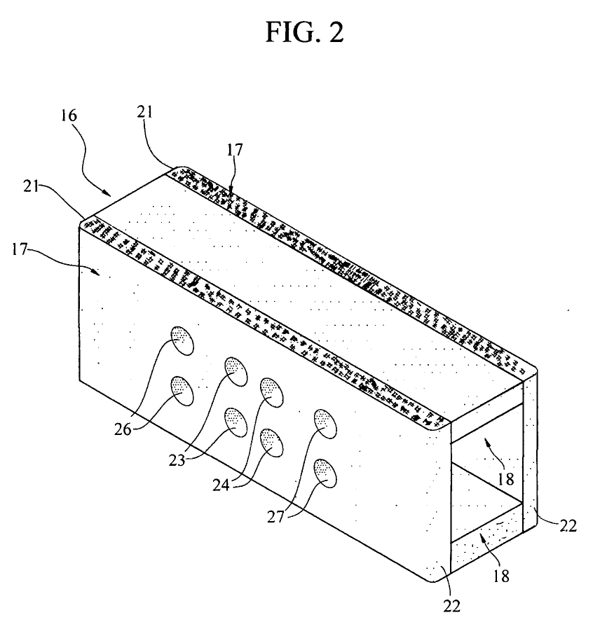

FIG. 2 is a perspective view of my shoe with abrasive elements represented by cross hatched areas;

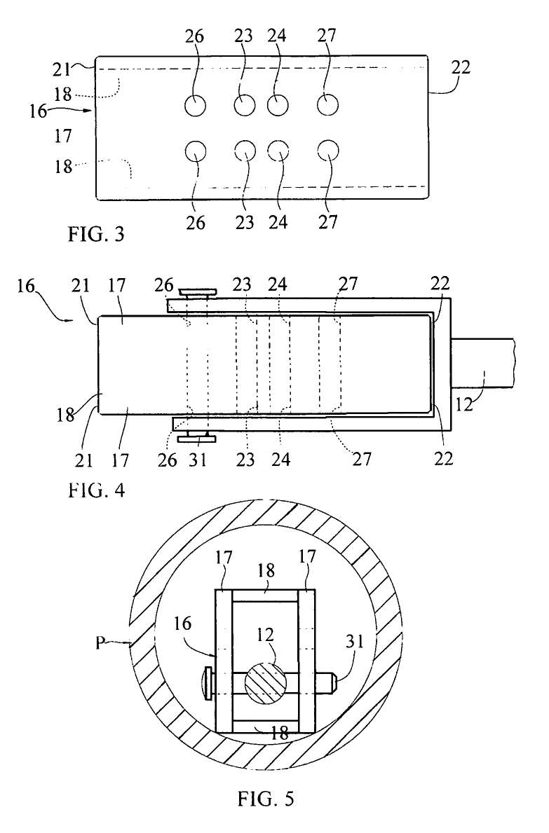

FIG. 3 is a side elevational view of the shoe;

FIG. 4 is a plan view of the shoe attached to a lance; and,

FIG. 5 is an end view of the shoe engaging the inner surface of a tube.

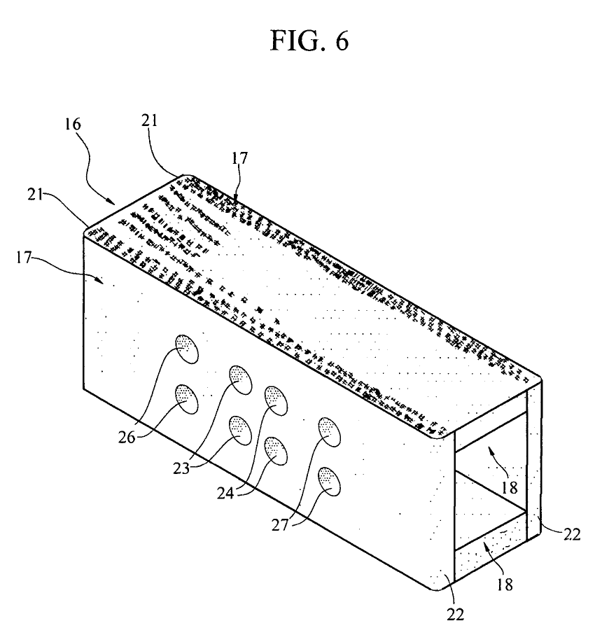

FIG. 6 is a perspective view of my shoe with abrasive elements represented by cross hatches.

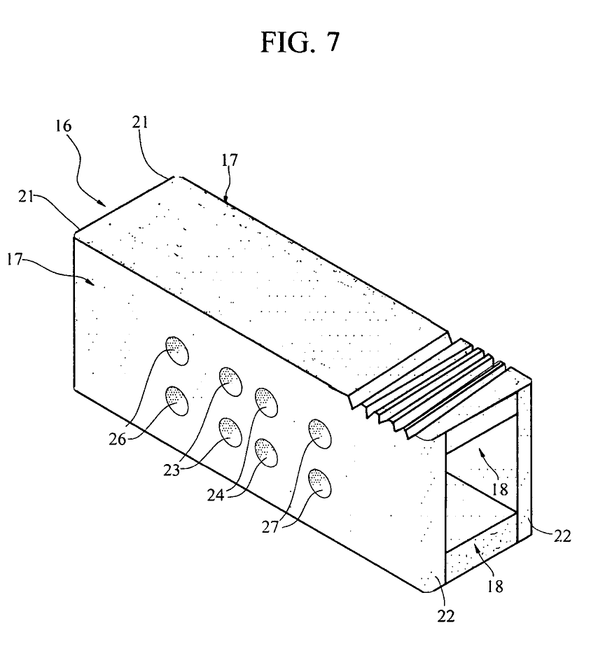

FIG. 7 is a perspective view of my shoe with the sacrificial surface formed by serrations in the surface of the shoe.

Referring to the drawings for a clearer understanding of the invention, it may be seen in FIG. 1 that the present invention is intended for use in either a pipe P manufacturing facility or a rework facility wherein the pipe is rotated on a cradle 11 about a horizontal axis. A pair of lances 12 are mounted coaxially with pipe P, and are actuated by a set of actuators 13 and 14. Actuator 14 urges the lance 12 longitudinally within the pipe P while actuator 13 displaces the lance vertically to position a shoe 16 mounted on the end of each lance 12.

Referring to FIGS. 2 and 5, it may be seen that each shoe 16 is generally box shaped in construction having a pair of side walls 17 and a pair of spaced apart transverse members 18. The side walls 17 are elongated, generally rectangular plates of a steel selected for its wear resistance and durability. Each shoe 16 can be reversible as explained hereinafter; however, for the purposes of illustration and explanation the side walls have two ends, designated front end 21 and rear end 22. Each side wall also has a plurality of ⅝-inch apertures in it at particular locations. Apertures 23 and 24 are located with their centers below the top of side wall 17 and medially inwardly from the front and rear ends. The apertures 23 and 24 are separated by about one half inch and lie on opposite sides of the mid-point of the shoe. Apertures 26 and 27, likewise, have their centers below the top of side wall 17, but are closer to the ends of the side wall. Transverse members 18 are welded to side walls 17 and in the prototype were ⅜-inch thick. Each may be positioned and welded with its exposed surface ¼ to ¾-inch from the near edges of side walls 17 as described in my prior patents or they may be welded flush with the near edges. The sizes of the shoe may vary with the size of the pipe being cleaned. As shown in FIGS. 3, 4, and 5, the shoe is affixed to the lance 12 by a pin or threaded connector 31 extending through lance 12 and apertures 26 closest to front end 21. From the foregoing it will be appreciated that the shoe may take the traditional H shape of my earlier patent, or may be a box or tube. In some instances it is preferred to make the unit from a solid piece of steel having approximately the same shape as a tube as shown in FIG. 4.

The improvement in removing pipe coatings has been achieved in the present invention by the addition of sacrificial surface to the shoe which is preferentially a layer of special cutting material to the grinding surfaces of the shoe as indicated at G. While selection of the steel for the shoe was helpful in grinding imperfections from the interior of the pipe itself, the shoe was not efficient at removing cement or glass coatings from finished pipe despite the use of various steel compositions in the shoe. Specifically, the improvement in removing cement or glass coating was discovered through experimentation with numerous materials used on the shoe, including hardened materials and materials designed for high heat applications, however it was found that cement, glass and resinous coatings could be removed by adding a layer of sacrificial tungsten carbide material to the working surfaces of the shoe.

As shown in FIG. 2, in one embodiment of the present invention side walls 17 each have applied to their top and bottom surfaces a layer 41 of material containing sintered tungsten carbide particles. Preferentially this layer is applied to the surfaces by a brazing or welding process such that the layer of particles extends along the full length of the sidewalls and may be about ⅛ to ½ inch thick. In another embodiment, shown in FIG. 6, wherein the shoe has a tube or box shape the tungsten carbide coating extends over substantially the entire working surface of the shoe and has or assumes a somewhat crowned surface from side wall to side wall as the shoe is used. It will be understood that the original shoes of my earlier inventions primarily performed their pipe cleaning at the edges of the shoe and presented linear surfaces bearing against the inside surface of the pipe such that defects in the pipe were sheared by the linear surface. However, with a coating that must be removed the linear edge of the shoe was ineffective to obtain a purchase on the coating. The tungsten carbide particles applied in layer 41 present a discontinuous surface that is able to obtain a purchase on the glass or cement liner and create surface discontinuities in the coating which can be effectively removed by the shoe such that the coating is completely removed from the pipe, whereupon the tungsten carbide particles engage the metal surface and effectively clean the surface of residual coatings. The tungsten carbide particles may be applied to the shoe in linear rows to form a layer using Kutrite® rods available from B & W Metals. The lines should run along the length of the shoe and transverse to the rotational motion of the pipe.

It has been found that using a finer particle composition in the layer 41 and a box or tubular shape a less aggressive finishing shoe may be used to smooth the interior of a pipe when the coating does not need to be completely removed or when the surface of the pipe need additional cleaning. Indeed, the box shaped shoe itself can be used for surface polishing.

In yet another embodiment, as shown in FIG. 7 the shoe has a sacrificial surface serrated (preferentially the serrations extend transversely of the shoe and are spaced evenly along the shoe) with a plurality of teeth formed thereon such that a linear edge is not presented to the rotating surface of the interior of the pipe. The serrations apply point pressure to the lining of the pipe and fracture the lining as the shoe is urged against the rotating pipe. When the serrations become worn as the shoe surface is sacrificed the shoe can be replaced by simply removing the pin and repositioning another shoe or turning the shoe over if the opposite side is serrated.

As in my prior shoe operations, the improved shoe can be set for greater or lesser grinding pressure by selecting the apertures used to connect the shoe to the lance. Connecting the shoe to the lance using a pin through the aperture closest to the front end increases the pressure applied by the grinding head and yields a smoother bore. Consequently, the shoe also wears faster in this mode. It should be noted that wear on the shoe occurs between the forward end and the connecting bolt, therefore as the forward end wears, the shoe may be reversed such that the relatively unworn rear end becomes the forward end, doubling the useful life of the shoe.

It will be appreciated that the improved shoe may be made from a solid steel bar having a width, length and height commensurate with the H or box shaped shoe as described above. In this embodiment of the shoe the end of the lance may be formed as a yoke and a retaining pin extends through the shoe and both sides of the yoke to hold the shoe in place as shown in FIG. 7. The yoke of the lance provides stability to the solid bar as it resists the lateral pressure of the rotating pipe in the same way the sides of the H shaped shoe does.

While my invention has been illustrated in various embodiments, it is to be understood that the combinations of features are not so limited and the scope of the invention is intended to be limited only by the breadth of the appended claims.

What is claimed is:

1. Apparatus for cleaning the interior of a length of pipe as said pipe is rotated about its longitudinal axis comprising: a shoe having a generally elongated shape and connected to a lance adapted for movement of said shoe along said pipe said shoe having a sacrificial surface for engaging the interior of said pipe.

2. Apparatus as defined in claim 1 wherein said sacrificial surface comprises a layer of tungsten carbide particles deposited on said shoe.

3. Apparatus as defined in claim 1 wherein said sacrificial surface comprises a layer of tungsten carbide particles deposited on said shoe in abutting rows extending longitudinally of said shoe.

4. Apparatus as defined in claim 1 wherein said sacrificial surface extends over substantially the entire width and length of said shoe.

5. Apparatus as defined in claim 4 wherein said sacrificial surface comprises a layer of tungsten carbide particles deposited on said shoe.

6. Apparatus as defined in claim 4 wherein said sacrificial surface comprises a layer of tungsten carbide particles deposited on said shoe in abutting rows extending longitudinally of said shoe.

7. Apparatus as defined in claim 4 wherein said sacrificial surface comprises a layer of abrasive particulate matter bonded to said shoe.

8. Apparatus as defined in claim 4 wherein said sacrificial surface is serrated.

9. Apparatus as defined in claim 1 wherein said sacrificial surface is serrated.

10. Apparatus as defined in claim 1 wherein said shoe is generally H shaped and with a pair of side walls connected by at least one cross member and wherein said sacrificial surfaces are located on said side walls.

11. Apparatus as defined in claim 10 wherein said sacrificial surfaces are serrated.

12. Apparatus as defined in claim 10 wherein said sacrificial surfaces comprise a layer of abrasive particulate matter bonded to said side walls.

13. Apparatus as defined in claim 12 wherein said sacrificial surfaces comprise a layer of tungsten carbide particulate matter.

14. Apparatus as defined in claim 1 wherein said shoe is solid.

15. Apparatus as defined in claim 14 wherein said sacrificial surface is serrated.

16. Apparatus as defined in claim 14 wherein said sacrificial surface comprises a layer of abrasive particulate matter bonded to one or more surfaces of said shoe.

17. Apparatus as defined in claim 14 wherein said sacrificial surface comprises a plurality of rows of tungsten carbide particulate matter extending along said shoe longitudinally.

18. Apparatus as defined in claim 14 wherein said lance is formed with a yoke on the end thereof proximal said shoe and with said connecting member extending through said shoe and said yoke.

19. Apparatus as defined in claim 1 wherein said shoe comprises a box having a pair of elongated side walls and a pair of elongated connecting walls joined to said side walls proximal the longitudinal edges of said side walls.

20. Apparatus as defined in claim 19 wherein said sacrificial surface comprises a plurality of rows of tungsten carbide particles bonded to at least one of said connecting walls and extending longitudinally along said shoe.
